(19) United States
(12) Patent Application Publication
(10) Pub. No.: US 2016/0009093 A1
(43) Pub. Date: Jan. 14, 2016

(54) SPLITABLE STAPLE FIBER NON-WOVEN USABLE IN PRINTER MACHINE CLEANING APPLICATIONS

(71) Applicant: ANDREW INDUSTRIES LTD., Accrington (GB)

(72) Inventors: Edward Duxbury ANDREW, Blackburn (GB); Alan LEBOLD, Niagara Falls, NY (US); Justin POPEK, Ogden, NY (US)

(21) Appl. No.: 14/330,150

(22) Filed: Jul. 14, 2014

(51) Int. Cl. B41J 2/165; D04H 1/42

(52) U.S. Cl. CPC B41J 2/16535; D04H 1/42; D10B 2505/00

(57) ABSTRACT

A non-woven textile constructed using splitable staple fibers is usable in lithographic and inkjet printer machine cleaning applications. The use of the splitable staple fiber non-woven in a lithographic printing machine provides improved removal and containment of waste inks, fluids, and paper dust within the printer machine. The use of the splitable staple fiber non-woven in an inkjet printing machine also provides removal of ambient particulate such as human hair or other particulate foreign to the printer machine contained within the printer machine. The cleaning ability of the non-woven textile is a function of several properties including the large amount of available fiber surface area per area of non-woven, the surface uniformity, the fibers' microscopic sharp edges, the capillary force, and the mechanical toughness provided by the highly entangled split staple fine denier fibers which make up the splitable staple fiber non-woven.

### FIELD OF THE INVENTION

The present invention is directed generally to a fluid cleaning textile for use in lithographic and ink jet printing systems. More specifically, the present invention is directed to a non-woven textile which is usable as an image transfer surface cleaning device in lithographic printer machines and as an inkjet nozzle-cleaning device in inkjet printer cleaning systems. Even more specifically, the present invention is directed to a non-woven textile largely comprised of low denier splitable staple fibers for use in lithographic blanket and cylinder ink-cleaning devices and in inkjet nozzle ink-cleaning cassettes. The non-woven fabric is manufactured utilizing at least 80 percent, by weight, splitable fibers each of less than 100 mm in length and which are purposely structured to become less than one denier in size during processing into a finished non-woven. Such a non-woven has a mass per unit area in the range from 20 grams per square meter (gsm) to 500 gsm and a measured air permeability value from 2 cubic feet per minute at ½ inch of water pressure (CFM), to 500 CFM. The present non-woven fabric most preferably has a peak tensile strength to mass per unit area ratio of at least 2.90 Newtons per 5 centimeters per GSM.

### BACKGROUND OF THE INVENTION

It is generally known in the art to use fabrics as cleaning media for printing machines. An inkjet printing machine cleaning fabric in disclosed in U.S. Pat. No. 6,957,881 to Nishina et al which describes the need to periodically maintain inkjet nozzle cleanliness and recites the use of a high density 0.1 denier fiber woven textile as a preferred media for an ink wiping device. Nishina does not disclose a specific fiber length nor make reference to a non-woven but does disclose the need for a cleaning fabric in an inkjet printing machine. A lithographic printer machine cleaning media is marketed as DuPont Sontara® PrintMaster and is advertised as providing a superior performance lithographic printer machine cleaning media due to its high absorbency, low linting, and high strength characteristics. Additionally, U.S. Pat. No. 5,974,976 to Gasparrini et al describes a reduced air content nonwoven fabric which is usable for cleaning various cylinders within a lithographic printing machine. Although Gasparrini does not claim any fiber detail comprising the non-woven, Sontara® is asserted as utilizing staple fibers which are equal to or more than 1 denier in size.

There is a continuing need to reduce printer machine down-time which, for the printer operator, equates to less waste, lower costs, less maintenance, and potentially higher profitability. A common configuration for a printer machine cleaning non-woven textile within a lithographic printer machine is in the form of a roll, which is installed into a housing cassette that is usable for periodically unwinding clean material, for delivering the clean non-woven material to the area requiring cleaning, and for rewinding consumed material within the cassette. Common configurations for printer machine cleaning non-woven materials within an inkjet printer encompass the aforementioned one, as well as rolls which do not unwind during use, continuous loop shapes, pads, or sheets, all of which are installed into a housing cassette which delivers the non-woven to the area requiring cleaning. The surface being cleaned in both lithographic and inkjet printer machines requires a non-woven to readily absorb fluid, to mechanically scrub and remove particulate from a surface, and also to retain the removed fluids and particulates, all without either depositing components of what comprises the non-woven or re-depositing any of the removed fluid and particulate.

It is common, in the prior art, to add woodpulp fibers to the composition of a non-woven to provided necessary absorbency. DuPont Sontara® PrintMaster acquires its high fluid absorbency through the use of a select amount of cellulose or woodpulp type fibers which are purposefully added to the non-woven construction. These natural fibers are well known to provide rapid and substantial absorbency similar to a “paper towel” used commonly for various applications. The limitation of this fiber type is its inherent nature to shed or to release portions of the woodpulp fibers upon contact with certain abrasive printer machine surfaces such as sharp nozzle plates, tacky rollers, or rough rollers, thus creating the need for an improved low-lint textile. Using synthetic man-made fibers and excluding the woodpulp content, as described in U.S. Pat. No. 7,745,358 to Benim et al, provides the ability to increase the shed resistance of a nonwoven by utilizing entirely synthetic fibers, such as polyester or poly(ethylene terephthalate).

It is also known to use continuous length filaments rather than staple fibers as one method to prevent fiber shed or fiber deposit. European patent 1,753,623 to Howey et al describes using a continuous filament synthetic construction which is thermally point-bonded to provide increased shed resistance. The two devices previously mentioned in European patent 1,753,623 to Howey et al, and U.S. Pat. No. 7,745,358 to Benim et al, increase the shed resistance of a non-woven but both discuss the use of thermal bonding to adhere the various components, when creating the final non-woven. Thermal bonding relies on a specific component of the non-woven to change phase from a solid to liquid and to then return to a solid. However, while this component is in the liquid phase, it tends to flow into adjacent components, thus acting as an adhesive within the non-woven structure. This reduces void space within the non-woven structure and also reduces fiber surface area, both of which negatively affect fluid absorbency and textile cleaning ability. If thermal point-bonding is not used in the construction of continuous length filament non-wovens, then these filaments are produced using the spunbond process which typically results in non-wovens having larger denier fibers. Such larger denier fibers will adversely affect mechanical cleaning ability or, if they are micro-denier sized, they can break and shed similarly to woodpulp containing non-wovens.

Freudenberg's Evolon® is an example of a micro-denier, continuous filament, cleaning non-woven and is detailed in U.S. Pat. No. 6,706,652 to Groten et al. BMP America first utilized Evolon® for lithographic and inkjet printer cleaning applications in 2004, recognizing that sub-denier or micro-denier splitable continuous filaments are preferred due to the amount of available surface area each fiber provides per surface area of finished textile. This high amount of available filament surface area provides a high amount of void space in which fluid can readily be absorbed. This is also supported by U.S. Pat. No. 7,745,358 Benim et al which also describes the addition of up to 10 percent of splitable staple micro-fibers to increase non-woven absorbency. When micro-denier splitable continuous filaments are highly entangled such as in Evolon®, the opportunity for a filament to break and shed exists but resistance to shed is much improved. Therefore, such micro-denier splitable continuous filaments have proven to be a viable option as a printer machine cleaning non-woven. However, they are challenging to manufacture and thus are costly. They also exhibit poor uniformity at lower basis weights.

The caliper thickness of such a non-woven, when used in a printer cleaning system, has a direct impact on the quantity of textile which can be contained within the delivery cassette. One way to decrease caliper thickness is to squeeze or calendar the non-woven to a lower caliper thickness value, as described in U.S. Pat. No. 5,974,976 to Gasparrini et al. However, calendaring often adds cost to a process, thus increasing final non-woven cost. It will thus be seen that a need exists for an improved non-woven which has the ability to mechanically scrub a surface, to present a uniform surface area, to absorb and retain waste, to resist shedding, to allow for quantitatively more non-woven within a given space, and to provide a cost advantage, all while meeting prior art non-woven strength specifications.

### SUMMARY OF THE INVENTION

An object of the present invention is to provide a non-woven textile suitable for use as a waste cleaning device for use in lithographic and inkjet printing machines.

Another object of the present invention is to provide a non-woven textile useable as a cleaning device for collecting and containing printer-ink.

Yet a further object of the present invention is to provide a printer-ink cleaning device that provides uniform and efficient removal of waste ink from an inked surface that is superior to prior art.

Typically, waste ink accumulates over time on a roller, cylinder, jacket, or print-blanket surface within a lithographic or offset printer. In accordance with the present invention, the non-woven fabric, when used as a lithographic printer ink cleaning device, can contact a surface which contains waste ink, will quickly remove such waste ink, and will resist fiber shed resulting from such contact with the surface containing the waste ink.

Inkjet printing typically relies on nozzles to spray atomized ink onto a printing media. Over time, these inkjet nozzles will collect excess ink and will also collect dust and other environmental contaminants, all of which need to be periodically cleaned and removed. In accordance with the present invention, the non-woven fabric, when used as an inkjet printer ink cleaning device, can contact a surface which contains waste ink and contaminants, such as a nozzle, will quickly remove such waste ink, and will resist fiber shed resulting from such contact with the surface containing the waste ink.

The present invention is directed to hydroentangled non-wovens which are formed from splitable staple fibers and which are suitable for use as strong, cost effective, and improved cleaning performance textiles that are utilized within offset and inkjet printing machines to clean various inked surfaces. The non-wovens have the ability to match or to surpass the cleaning ability of a continuous filament micro-denier non-woven, to surpass the tensile strength per unit mass ratio of commercially available printer machine cleaning non-wovens, to surpass the fiber uniformity of continuous filament non-wovens, to surpass the shed resistance of a continuous filament micro-denier non-woven and woodpulp or cellulose containing non-wovens, to match or surpass the absorbency of wood-pulp or cellulose containing non-wovens, and to be cost competitive in the commercial marketplace.

An important characteristic of the non-woven fabric in accordance with the present invention is its tensile strength to mass per unit area ratio. This value is determined by dividing the peak tensile strength of the non-woven by the weight per unit area of that non-woven. As an arbitrary numerical example, if a non-woven sample has a measured weight of 50 grams per square meter (gsm) and is measured to have a peak tensile strength of 100 Newtons per 5 centimeter (N/5 cm), that non-woven has a strength to weight ratio of 2 N/5 cm/gsm. Superior tensile strength to mass per unit area ratios indicate a higher entanglement of fibers and an overall improved non-woven construction, fiber structure, and uniformity.

Another important characteristic of the non-woven fabric of the present invention is the fiber size, quantified by denier and length, which comprises the non-woven. The fiber size is obtained by utilizing purposefully made splitable staple fibers of less than 100 mm in length and by mechanically processing the splitable fibers to obtain a highly tangled and uniform non-woven fabric largely consisting of fibers which have become smaller than one denier due to processing. Fibers which are smaller than one denier will be referred to as microdenier fibers and are synonymous with the term microfiber.

Splitable microdenier continuous filaments, as opposed to staple fibers, were introduced to ink cleaning applications by BMP in 2004 based on the recognition of the high amount of available surface area per unit volume of such filaments, which allowed for superior cleaning and fluid absorbency. This structure is also mechanically tough. However, an inherent limitation of non-wovens which contain continuous filaments is poor uniformity, when produced in relatively low basis weights and particularly in weights of less than 80 grams per square meter. The use of a split staple microfiber provides the non-woven of the subject invention with a uniform distribution of mass per unit area and a mechanically tough structure due to the staple fiber's ability to entangle in three dimensions within the textile versus a more typical two dimensional entanglement, which is common among non-wovens which contain continuous filaments. The high degree of staple microfiber entanglement and uniformity is also present when producing textiles at basis weights of less than 80 grams per square meter, which is the weight range where continuous microfiber textiles struggle.

Uniform distribution of mass within the non-woven is a direct result of the ability to process the staple fiber through a non-woven carding machine. The carding machine parameters and the staple fiber length are both specified to provide improved distribution, while longer fibers or other processes for creating a non-woven structure, such as the spunbond process, adversely affect mass distribution. After the splitable staple fibers are further processed and are split into smaller microdenier fibers, the mass distribution uniformity is only improved beyond the carding machine capability.

One way of measuring such uniformity is to test and to record air permeability at various locations throughout the finished textiles and to then compare the standard deviation of readings between the different textiles. The split staple microdenier textile, in accordance with the present invention, has a much lower standard deviation, which correlates to higher uniformity. The increased uniformity of microfibers, per unit area of the non-woven, provides a highly tangled structure which is shed resistant and mechanically superior, when compared to similar non-woven structures which are composed of larger denier or of continuous length fibers. The uniform structure also provides a strong capillary force which results in the non-woven having an affinity for ink in printer cleaning applications.

Capillary force in a non-woven is a function of the surface tension of fluid with respect to fiber type, of the contact angle of the fluid on the fiber and of the fiber surface area per unit volume of the non-woven. Capillary force in a non-woven is analogous to capillary head in a vertical capillary tube. This is based on the concept that the space between the fibers in the non-woven can be approximated as a vertical capillary tube. The equation for force in a vertical capillary tube is given as follows:

F=2πrσ_{LV} cos θ_{LS}

where,
F=Capillary Force
r=Tube Radius
σ_{LV}=Surface Tension
θ_{LS}=Contact Angle
   The fiber surface area, per unit volume of the non-woven, is a function of the non-woven's density and fiber size. The equation for fiber surface area, per unit volume of the non-woven, is given as follows:

$$S A = ( \frac{4}{{d}_{f}} ) ( \frac{ρ}{{ρ}_{f}} )$$

where,
SA=fiber surface area per unit volume
d_{f}=diameter of fiber
ρ=density of non-woven needlefelt
ρ_{f}=density of fiber
   A higher SA will create many individual capillary tubes within the non-woven thus creating a high capillary force, F in the non-woven.

The splitable staple fiber non-woven in accordance with the present invention overcomes the limitations of the prior materials. It is a substantial advance in the art.

### BRIEF DESCRIPTION OF THE DRAWINGS

While the novel features of the splitable staple fiber non-woven useable as an ink cleaning device in accordance with the present invention are set forth with particularity in the appended claims, a full and complete understanding of the invention may be made by referring to the detailed description of the preferred embodiments, as presented subsequently, and as illustrated in the accompanying drawings in which:

FIGS. 1A and 1B are plan views of the splitable staple fiber non-woven useable as an ink cleaning device in accordance with the present invention,

FIG. 1C is a plan view of a similar basis weight, prior art continuous filament microdenier non-woven;

FIG. 2A is a magnified (cross-sectional) views showing an appearance of the non-woven useable as an ink cleaning device in accordance with the present invention, compared to a similar basis weight continuous filament microdenier non-woven, as shown in FIG. 2B;

FIG. 3A is a schematic view showing the appearance of staple splitable fibers largely comprising the nonwoven usable as an ink cleaning device in accordance with the present invention, as compared to a schematic view showing the appearance of continuous filaments in FIG. 3B;

FIG. 4 is a cross-sectional view showing the appearance of a staple splitable fiber largely comprising the nonwoven usable as an ink cleaning device in accordance with the present invention;

FIG. 5 is a photograph showing a roll of the splitable staple fiber non-woven useable as an ink cleaning device in accordance with the present invention;

FIG. 6 is a chart showing the air permeability of prior art Evolon® 60 gsm nominal weight material;

FIG. 7 is a chart showing the air permeability of the splitable staple fiber non-woven in accordance with the present invention configured as a 60 gsm nominal weight material;

FIG. 8 is a chart showing the air permeability of the splitable staple fiber non-woven in accordance with the present invention configured as a 40 gsm nominal weight material; and

FIG. 9 is a representation of one manufacturing process of the present non-woven invention.

### DETAILED DESCRIPTION OF THE PREFERRED EMBODIMENT

The term non-woven, as used herein, refers to a textile without a specified pattern or quantity of fibers or filaments oriented in specific axes of the textile surface. The term can also be defined as the opposite structure of a knitted or woven textile structure.

The term hydroentangled, as used herein, describes a non-woven manufacturing method in which the fibers are locked into place and entangled using high pressure fluid jets.

The term splitable, as used herein, is used to describe a fiber that reduces its size when processed through a variety of steps. The fiber is typically composed of more than one polymeric substance contained within the same filament and is formed in a way such that the multiple polymers are segmented and separable by chemical or physical means. Common splitable fiber cross section structures include, but are not limited to, segmented pie, “islands in the sea,” segmented tri-lobes, segmented cross, segmented ribbons, striped round fibers, hollow fiber core, and hollow segmented pie. Common polymers used include, but are not limited to, polyethylene terephthalate (polyester or PET), co-polyester, Polyamide (Nylon 6 or Nylon 6,6), polypropylene, polyethylene, and polyvinyl alcohol.

The term staple is used to describe a natural fiber or a finite length synthetic fiber which has been cut from a filament. Typical cut length of the staple fiber is between 0.2 inches and 6 inches.

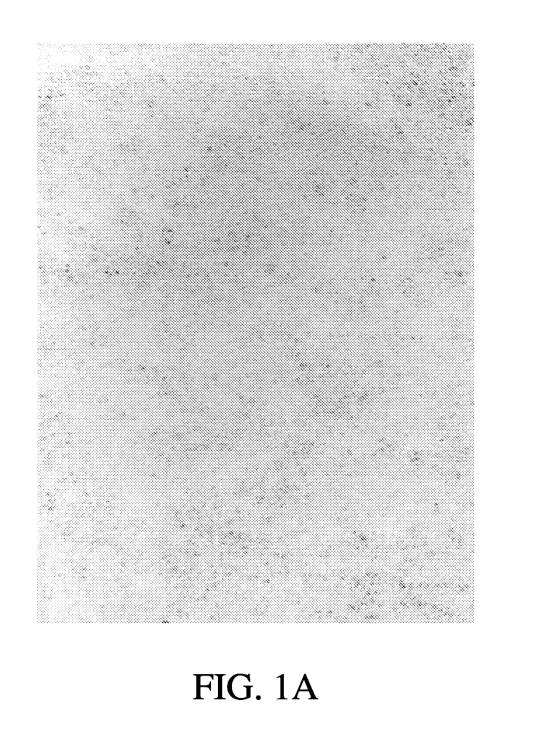

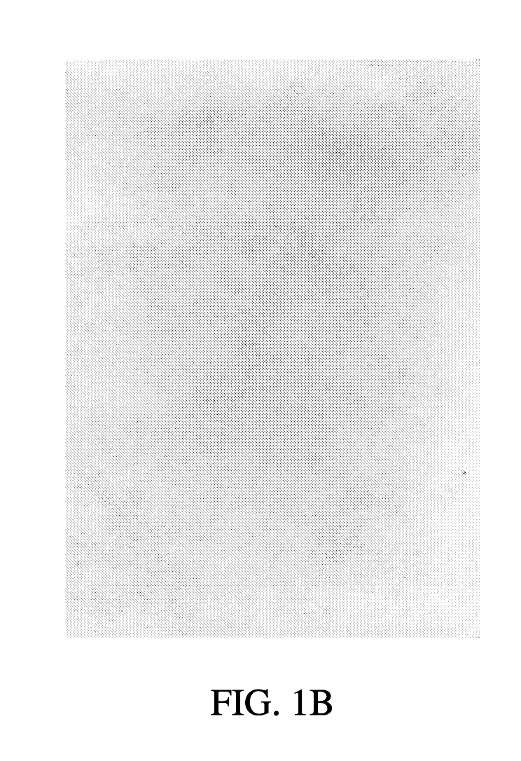

FIGS. 1A, 1B, and 1C are photos of three different non-wovens. FIG. 1A is a photo of a 45 gsm nonwoven composed of splitable staple fibers, in accordance with the present invention, and is shown to demonstrate the macroscopic uniformity of a sub-80 gsm textile. Small areas of textile may still exhibit zero fiber content. However, these areas are typically not significant enough to affect cleaning performance in most applications wherein a surface to be cleaned is contacted multiple times during a cleaning cycle. FIG. 1B is a photo of a 60 gsm non-woven composed of splitable staple fibers, in accordance with the present invention, and shows the most uniform fiber distribution. This photo demonstrates the superior non-woven uniformity that is attained from this invention. FIG. 1C is a photo of a 60 gsm prior art micro-denier splitable continuous filament non-woven which has similar macroscopic uniformity compared to the 45 gsm nonwoven composed of splitable staple fibers in accordance with the present invention.

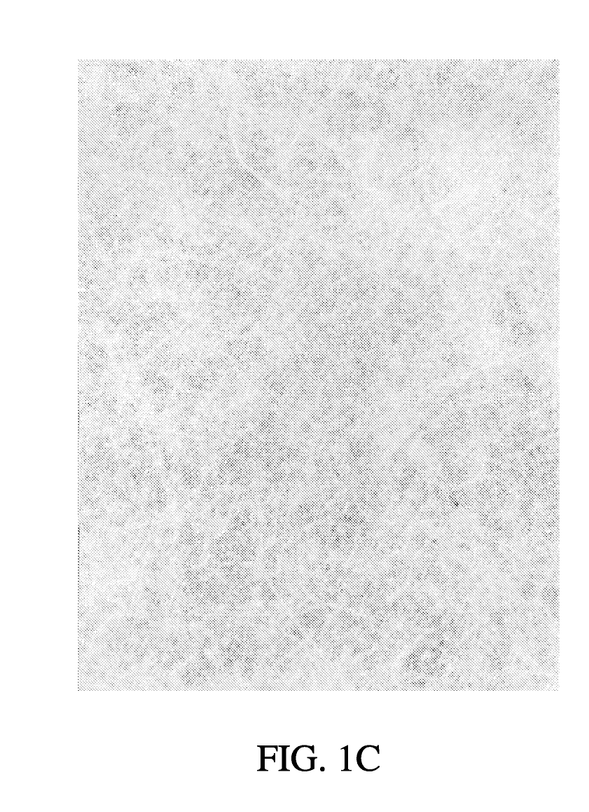

FIGS. 2A and 2B are two scanning electron microscope photos of a magnified cross-sectional view comparing a splitable staple fiber non-woven, in accordance with the present invention in FIG. 2A, to a prior art continuous filament microdenier non-woven shown in FIG. 2B. The photo identified as the splitable staple fiber non-woven in FIG. 2A shows a higher degree of fibers entangled through the cross section of the textile or “Z-direction” of the textile (considering the X-Y plane to be the face of the textile).

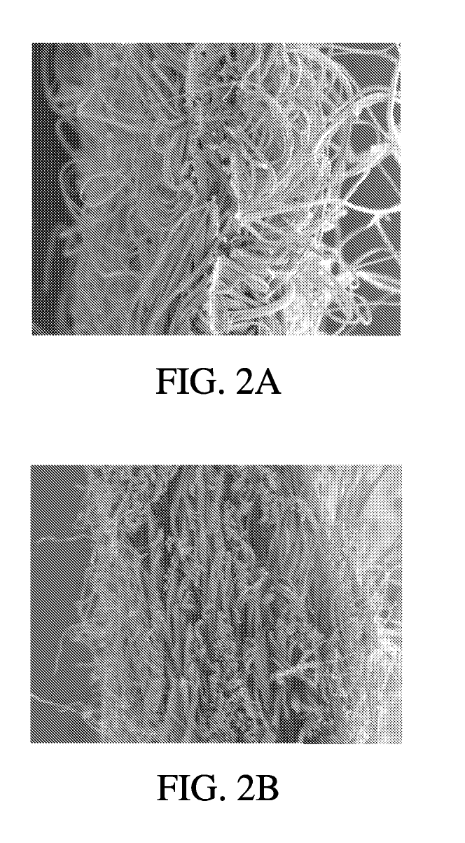

FIGS. 3A and 3B provide a visual representation of the primary difference between staple fibers, as shown in FIG. 3A, and continuous filaments, as shown in FIG. 3B. These visual representations also help provide a visualization of the higher degree of entanglement which is potentially available from staple fibers versus continuous filaments.

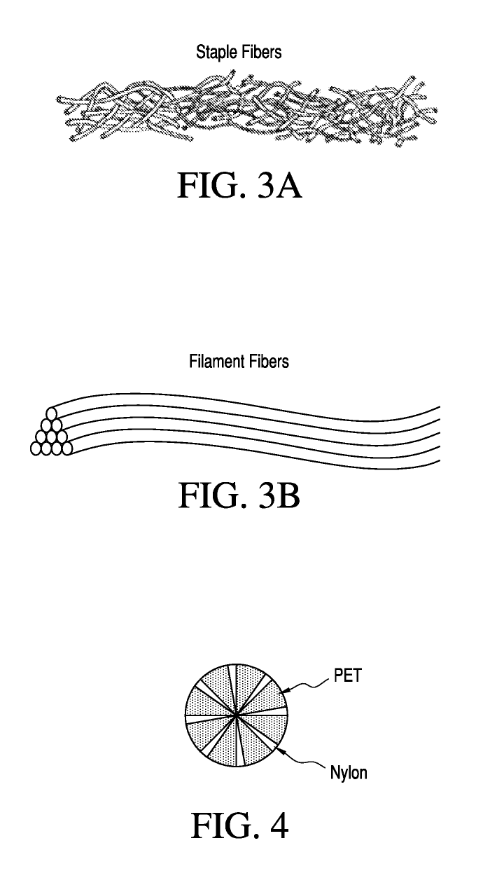

FIG. 4 is a cross-sectional view showing the appearance of a single staple splitable fiber which largely comprises the splitable staple fiber nonwoven usable as an ink cleaning device in accordance with the present invention. The cross-section of a suitable single staple splitable fiber is not limited to this structure or polymer set, as described previously. Suitable splitable fiber cross section structures that are usable in the present invention include, but are not limited to, segmented pie, “islands in the sea,” segmented tri-lobes, segmented cross, segmented ribbons, striped round fibers, hollow fiber core, and hollow segmented pie. Common polymers which may be used include, but are not limited to, polyethylene terephthalate (polyester or PET), co-polyester, Polyamide (Nylon 6 or Nylon 6,6), polypropylene, polyethylene, and polyvinyl alcohol.

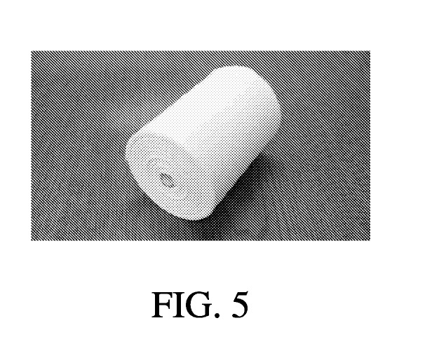

FIG. 5 is a photograph showing the appearance of the splitable staple fiber non-woven useable as an ink cleaning device, in accordance with the present invention, in roll form. This roll form depiction is provided as a visual example and is not intended to limit the present invention to any specific delivery form. Other potential forms of delivery include, but are not limited to, sheets, pads, belts, loops, cassettes, and formed shapes.

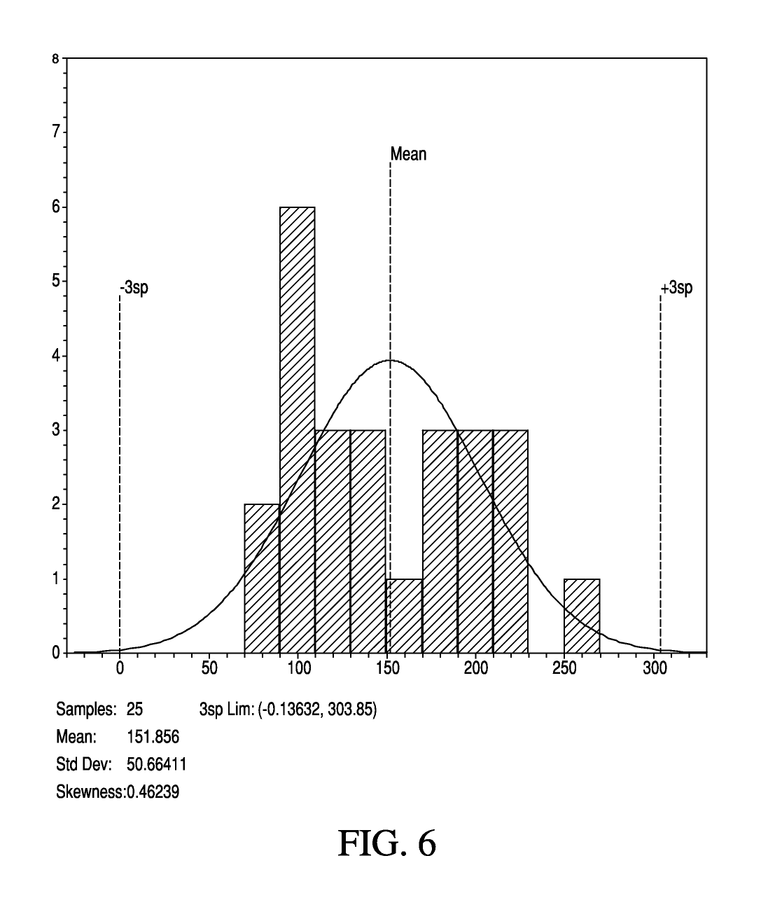

FIG. 6 is a chart showing twenty five air permeability readings of prior art Evolon® 60 gsm nominal weight material in units of CFM/ft² at ½ inch of water pressure. This chart can be used as a comparative tool to compare the uniformity of the prior art textile with the present invention. These values provide an average reading of 151 CFM/ft² and a standard deviation of 50.66.

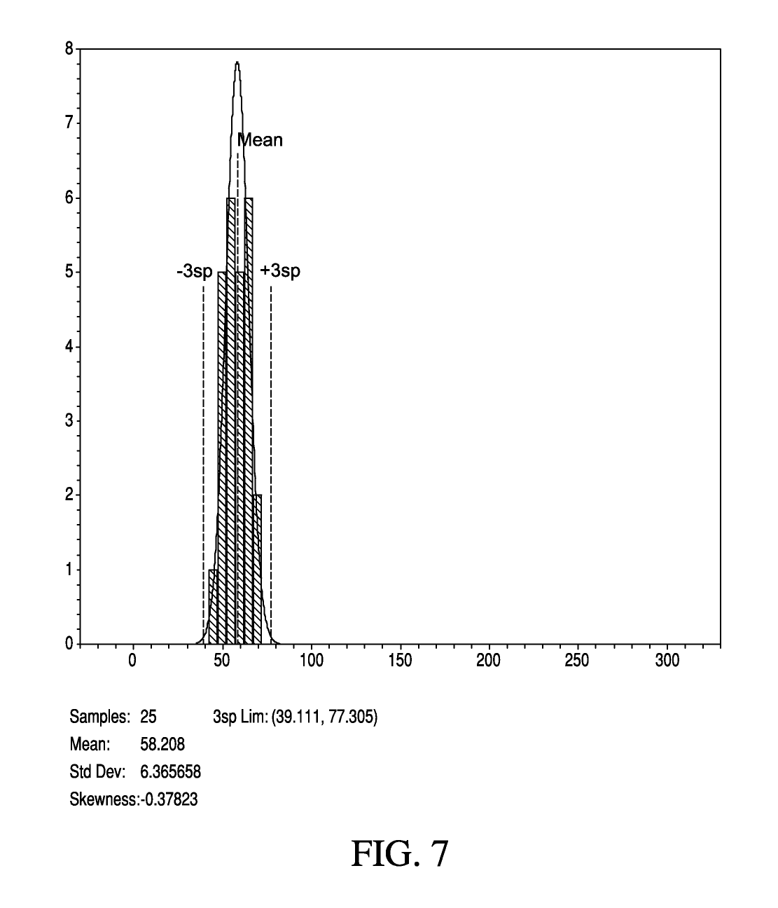

FIG. 7 is a chart showing twenty five air permeability readings of the splitable staple fiber non-woven 60 gsm nominal weight material, in accordance with the present invention, in units of CFM/ft² at ½ inch of water pressure. The chart can be used as a comparative tool to characterize the uniformity of the textile. These values provide an average reading of 58.208 CFM/ft² and a standard deviation of 6.36 which should be noted as being a significant improvement compared to FIG. 6.

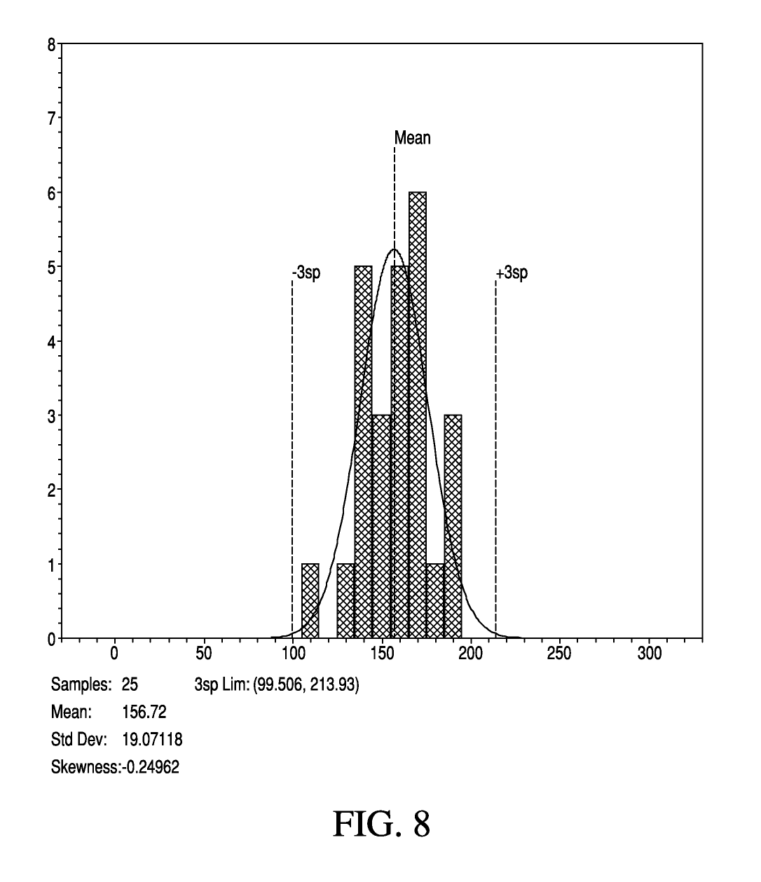

FIG. 8 is a chart showing twenty five air permeability readings of the present splitable staple fiber non-woven, provided as a 40 gsm nominal weight material, in accordance with the present invention, in units of CFM/ft² at ½ inch of water pressure. This chart can also be used as a comparative tool to characterize the uniformity of the textile of the present invention. These values provide an average reading of 156.72 CFM/ft² and a standard deviation of 19.07 which is a substantial improvement compared to FIG. 6.

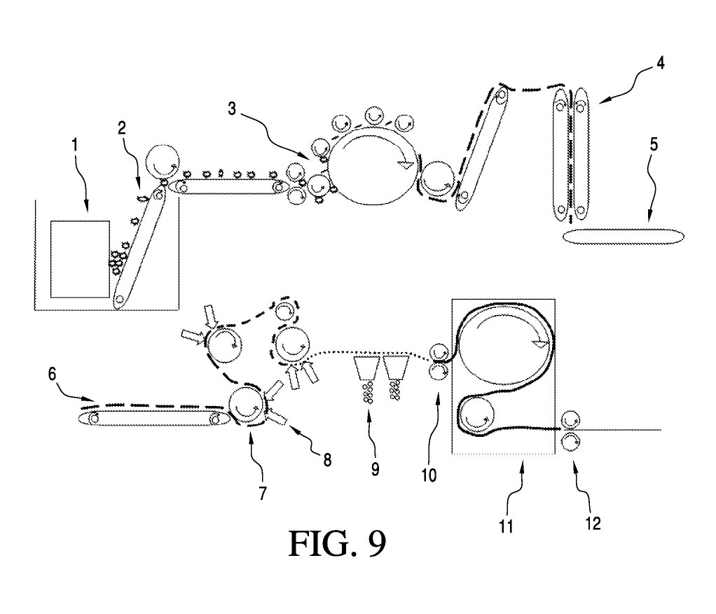

FIG. 9 is a schematic depiction of one manufacturing process for making a splitable staple fiber non-woven in accordance with the present invention. A bale of staple splitable fibers 1 from a commercial source is mechanically opened by a conveyor belt 2 and fibers are sent to a carding machine 3 which provides a uniform distribution of fibers in the form of a web. The fibrous web is transported to a lapping machine 4 which layers the web in accordance with a desired target mass per unit area. The lapper 4 can provide layering in the same direction (or machine direction) of the manufacturing process. The lapper 4 can also provide layering in the perpendicular direction (or cross direction) of the manufacturing process. Multiple lappers can also be used before a conveyor belt 5 transports the layered web to the next process, which is a mechanical fiber splitting process. Splitting can be done in many physical or chemical ways, one way being hydro-entanglement, which is shown, as the layered web 6 is transported to perforated cylinders 7 which receive water that is directed out of opposing high pressure nozzles 8. This drawing shows three sets of perforated cylinders 7 each having a set of nozzle jets 8. The number of sets of perforated cylinders 7 can vary as long as the equipment can provide enough force to achieve the strength and uniformity properties desired for the splitable staple fiber non-woven in accordance with the present invention. A vacuum system 9 is then used to remove excess water from the now hydro-entangled non-woven before it is optionally squeezed with rollers 10 that further remove any residual excess water. The splitable staple fiber non-woven in accordance with the present invention is then sent through a drying system 11 before being optionally calendared at a calendaring station 12 to a lower thickness. Alternatively, the layered web can be mechanically split using needle punch technology or can be chemically split by dissolving a carrier membrane which surrounds the staple microfiber. Other splitting and entanglement procedures are also within the scope of the present invention.

### EXAMPLES

### Example #1

In this first example, 51 mm long EASTLON 2.0 denier mechanically splitable staple microfibers, composed of polyester and nylon, are processed through a bale opening machine (2 in FIG. 9) and a carding machine 3 to uniformly spread the fibers across the width of a moving belt 4. The belt 4 transports the web of fibers or multiple layers of webs 5, targeting a total final weight of 60 grams per square meter, to a series of high pressure water jets 8 and perforated cylinders 7. Water jet orifices of the water jets 8 are spaced between 0.5 mm and 1.0 mm apart and with diameters ranging from 100 to 160 microns. Pressures of approximately 200 bar are used to split and to three-dimensionally entangle the splitable staple microfibers at multiple hydroentangling stations along the production path. The resultant split and entangled textile is then vacuum dried, using vacuum system 9, squeezed using rollers 10 and heated in drying system 11 to remove all water content.

The result is a splitable staple microfiber 63 gram per square meter (gsm) textile (ASTM D-461 Section 11) with a thickness of 0.39 millimeters (ISO 9073-2) and an average peak tensile strength, in the machine direction, of 269 Newtons per 5 centimeters (N/5 cm) (ASTM D-5035-11). The ratio of this peak strength to weight is 4.27 N/5 cm per gsm. In comparison, Freudenberg's prior art Evoion®, at a weight of 60 gsm, has a measured average peak tensile strength, in the machine direction, of 165 N/5 cm and a strength to weight ratio of 2.75 N/5 cm per gsm. Air permeability testing is one way to compare material uniformity. As discussed previously, FIG. 6 shows twenty five air permeability readings (CFM/ft² at ½″ of H₂O) of Freudenberg's prior art Evolon® at a weight of 60 gsm. These measurements were recorded using a Textest model FX3300 from TexTest AG, Zurich, Switzerland. The standard deviation of these readings is 50.66. This can be compared to 6.36, which is the standard deviation of twenty five readings of the 60 gsm target staple split textile in accordance with the present invention. The dramatically lower standard deviation of the present invention directly correlates to improved fiber uniformity which contributes to the significant strength to weight ratio of 4.27 N/5 cm per gsm of the subject invention.

The splitable staple fiber three dimensional entanglement of the present invention provides much better resistance to shed than does Freudenberg's prior art Evolon® which is more two dimensionally entangled. Abrasion resistance of the present invention textile was compared to that of Evolon® using a model 5130 Taber Abraser from Teledyne Taber, North Tonawanda, N.Y. Weight loss per unit area abraded was recorded in milligrams per square centimeter (mg/CM²) and thickness loss was recorded in millimeters and was converted to percent thickness loss. Samples were tested for 100 cycles using an H-18 abrasion wheel with 1500 grams of total weight on each arm. The target 60 gsm textile of the present invention lost 113 mg/cm² and 16.0% of its original thickness while Evolon® 60 gsm lost 321 mg/cm² which is a factor of 2.8 times the 60 gsm textile amount, of the present invention and lost 22.4% of the original thickness which is a factor of 1.4 times the 60 gsm textile amount of the present invention. Thus, the present invention, of a splitable staple fiber non-woven has an improved tensile strength to mass per unit area ratio, improved uniformity, and improved resistance to shed while maintaining the prior art non-woven ability to mechanically scrub a surface and to absorb and retain waste.

### Example #2

In this example, 51 mm long EASTLON 2.0 denier mechanically splitable staple microfibers, composed of polyester and nylon, are processed through a bale opening machine (2 in FIG. 9) and a carding machine 3 to uniformly spread the fibers across the width of a moving belt 4. The belt 4 transports the web of fibers or multiple layers of webs 5, targeting a total final weight of 40 grams per square meter, to a series of high pressure water jets 8 and perforated cylinders 7. Water jet orifices of the water jets 8 are spaced between 0.5 mm and 1.0 mm apart with diameters ranging from 100 to 160 microns. Pressures of approximately 200 bar are used to split and to three-dimensionally entangle the splitable staple microfibers at multiple hydroentangling stations along the production path. The resultant split and entangled textile is then vacuum dried, using vacuum system 9, squeezed using rollers 10, and heated in drying system 11 to remove all water content.

The result is a splitable staple microfiber, 38 gram per square meter (gsm), textile (ASTM D-461 Section 11) with a thickness of 0.27 millimeters (ISO 9073-2) and an average peak tensile strength, in the machine direction, of 154 Newtons per 5 centimeters (N/5 cm) (ASTM D-5035-11). The ratio of this peak strength to weight is 4.05 N/5 cm per gsm. Recall that Freudenberg's prior art Evoion®, at a weight of 60 gsm, has a measured average peak tensile strength in the machine direction of 165 N/5 cm and a strength to weight ratio of 2.75 N/5 cm per gsm. As discussed, FIG. 8 shows twenty five air permeability readings (CFM/ft² at ½″ of H2O) of the 40 gsm target weight textile in accordance with the present invention. These measurements were recorded using a Textest model FX3300 from TexTest AG, Zurich, Switzerland. The standard deviation of these readings is 19.07 compared to the previously mentioned 50.66 value of Freudenberg's Evolon® 60 gsm, thus supporting the fact that splitable staple nonwovens can be made more uniform at lower basis weights compared to continuous filament nonwovens. Thus, the present invention provides a splitable staple fiber non-woven, which has an improved tensile strength to mass per unit area ratio and improved uniformity, while maintaining the prior art non-woven ability to mechanically scrub a surface, and to absorb and retain waste, to allow for quantitatively more non-woven within a given space, and to provide a cost advantage by reducing the amount of textile weight per unit area.

### Example #3

In this example, 51 mm long EASTLON 2.0 denier mechanically splitable staple microfibers, composed of polyester and nylon, are processed through a bale opening machine 2 and a carding machine 3 to uniformly spread the fibers across the width of a moving belt 4. The belt 4 transports the web of fibers or multiple layers of webs 5, targeting a total final weight of 170 grams per square meter, to a series of high pressure water jets 8 and perforated cylinders 7. Water jet orifices of the water jets 8 are spaced between 0.5 mm and 1.0 mm apart with diameters ranging from 100 to 160 microns. Pressures of approximately 200 bar are used to split and to three-dimensionally entangle the splitable staple microfibers at multiple hydroentangling stations along the production path. The resultant split and entangled textile is then vacuum dried, using vacuum system 9, squeezed using rollers 10, and heated in drying system 11 to remove all water content.

The result is a splitable staple microfiber, 162 gram per square meter (gsm), textile (ASTM D-461 Section 11) with a thickness of 0.76 millimeters (ISO 9073-2) and an average peak tensile strength, in the machine direction, of 595 Newtons per 5 centimeters (N/5 cm) (ASTM D-5035-11). The ratio of this peak strength to weight is 3.67 N/5 cm per gsm. Freudenberg's prior art Evolon® at a weight of 160 gsm, has a measured average peak tensile strength, in the machine direction, of 417 N/5 cm and a strength to weight ratio of 2.61 N/5 cm per gsm, once again demonstrating that the subject invention provides a splitable staple fiber nonwoven matching or surpassing the strength of a continuous filament nonwoven. Thus, the present invention provides a splitable staple fiber non-woven which has an improved tensile strength to mass per unit area ratio while maintaining the ability of the prior art non-woven to mechanically scrub a surface and to absorb and retain waste.

While preferred embodiments of a Splitable staple fiber non-woven useable as an ink cleaning device, in accordance with the present invention, have been set forth fully and completely hereinabove, it will be apparent to those persons skilled in the art that various changes and modifications may be made without departing from the spirit and scope thereof which is accordingly limited only by the following claims.

What is claimed is:

1. A cleaning material for use in a printer comprising: a non-woven material having finite length staple splitable fibers forming a uniform web which yields a non-woven with a strength to weight ratio of at least 2.90 Newtons per 5 centimeters per GSM.

2. The cleaning material of claim 1 wherein at least 80 percent of the staple splitable fibers are composed of a man-made polymer.

3. The cleaning material of claim 2 wherein at least 80 percent by weight of the staple splitable fibers are larger than 1 denier prior to processing and less than 1 denier after processing.

4. The cleaning material of claim 3 wherein the staple splitable fibers are each less than 100 mm in length.

5. The cleaning material of claim 1 wherein the nonwoven material has a basis weight in the range of 20 grams per square meter (gsm) to 500 gsm

6. The cleaning material of claim 1 wherein the finite length staple splitable fibers are mechanically split using heat and pressure.

7. The cleaning material of claim 1 wherein the finite length staple splitable fibers are mechanically split using high pressure water jets.

8. The cleaning material of claim 1 wherein the finite length staple splitable fibers are mechanically split using needle punch technology.

9. The cleaning material of claim 1 wherein the finite length staple splittable fibers are chemically split by dissolving a carrier membrane which surrounds the staple microfiber.
